(19) United States
(12) Patent Application Publication
(10) Pub. No.: US 2014/0002336 A1
(43) Pub. Date: Jan. 2, 2014

(54) PERIPHERAL DEVICE FOR VISUAL AND/OR TACTILE FEEDBACK

(71) Applicant: Greg D. Kaine, Sunnyvale, CA (US)

(72) Inventor: Greg D. Kaine, Sunnyvale, CA (US)

(21) Appl. No.: 13/534,784

(22) Filed: Jun. 27, 2012

(51) Int. Cl. G06F 3/01

(52) U.S. Cl. 345/156

(57) ABSTRACT

Methods, apparatuses and storage medium associated with facilitating human-computer interaction are disclosed herein. In various embodiments, a peripheral device may include a device body having a cavity configured to receive one or more hands of a user of the computing device, and a plurality of sensors disposed inside the cavity to collect position, posture or movement data of the one or more hands as the user uses the one or more hands to interact with the computing device. The peripheral device may further include at least a selected one of a display screen disposed on an external surface of the body or a variable texture surface disposed inside the cavity to provide at least a corresponding selected one of visual or tactile feedback to the user, based at least in part on the position, posture or movement data of the one or more hands. Other embodiments may be disclosed or claimed.

### TECHNICAL FIELD

This application relates to the technical field of data processing, more specifically to methods and apparatuses associated with facilitating human-computer interaction.

### TECHNICAL FIELD

The background description provided herein is for the purpose of generally presenting the context of the disclosure. Unless otherwise indicated herein, the materials described in this section are not prior art to the claims in this application and are not admitted to be prior art by inclusion in this section.

Since the advance of computing, sensory modalities of human-computer interaction have been limited to sight and sound. Other senses such as touch, taste and smell generally have not been integrated into the experience. Currently, there is no known economically viable solution for providing a means to replicate tactile sensory experience, such as the feel of a quilt, the sensation of a concrete surface, and so forth, especially for lower cost personal computing.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIGS. 1-4 illustrate, respectively, a perspective view, an end view, a side view, and a top view of an example peripheral device for facilitating human-computer interaction;

FIG. 5 illustrates various example usage of the peripheral device;

FIG. 6 illustrates an architectural or component view of the peripheral device;

FIG. 7 illustrates a method of human-computer interaction, using the peripheral device; and

FIG. 8 illustrates an example non-transitory computer-readable storage medium having instructions configured to practice all or selected aspects of the method of FIG. 7; all arranged in accordance with embodiments of the present disclosure.

### DETAILED DESCRIPTION

Methods, apparatuses and storage medium associated with facilitating human-computer interaction are disclosed. In various embodiments, a peripheral device may include a device body having a cavity configured to receive one or more hands of a user of the computing device, and a plurality of sensors disposed inside the cavity to collect position, posture or movement data of the one or more hands as the user uses the one or more hands to interact with the computing device. The peripheral device may further include at least a selected one of a display screen disposed on an external surface of the body or a variable texture surface disposed inside the cavity to provide at least a corresponding selected one of visual or tactile feedback to the user, based at least in part on the position, posture or movement data of the one or more hands.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”.

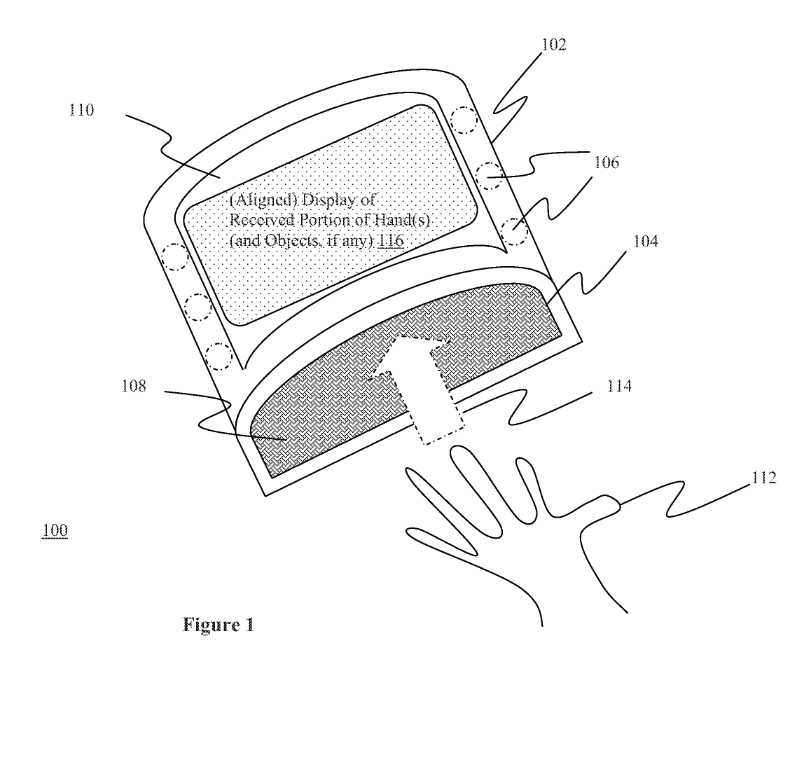

FIGS. 1-4 illustrate, respectively, a perspective view, an end view, a side view, and a top view of an example peripheral device for facilitating human-computer interaction. As illustrated in FIG. 1, in various embodiments, example peripheral device 100, suitable for use to facilitate user interaction with a computing device (not shown in FIG. 1) (or more specifically, with an operating system or an application of the computing device), may include device body 102 having a cavity 104 configured to receive one or more hands 112 of a user of the computing device. Peripheral device 100 may include a number of sensors 106 disposed inside the cavity (as depicted by the dotted lines) to collect position, posture or movement data of the one or more hands 112 as the user moves and/or postures the one or more hands 112 to interact with the computing device. In embodiments, the data collected may include any real object the user's hands may be holding or interacting. Sensors 106 may be any one of a number of acoustic, opacity, geomagnetism, reflection of transmitted energy, electromagnetic induction or vibration sensors known in the art. Sensors 106 may be disposed in other locations, and are not limited to the locations depicted in FIG. 1 for illustration purpose.

In embodiments, peripheral device 100 may further include at least a selected one of a display screen 110 disposed on an external surface of body 102, e.g., the top surface, and/or a variable texture surface 108 disposed inside cavity 104, e.g., on the inside bottom surface, to correspondingly provide visual 116 and/or tactile feedback to the user, based at least in part on the position, posture or movement data of the one or more hands 112. Display screen 110 may be any one of a number of display screens, such as, but not limited to, thin film transistors or liquid crystal display, known in the art. Variable texture surface 108 may be a surface configured to provide relatively tow fidelity haptic feedback. For example, surface 108 may be an electrostatic vibration surface available from Senseg of Espoo, Finland. In still other embodiments, surface 108 may also provide feedback in the form of heat, pressure, sensation of wind, and so forth.

In FIG. 1, arrow 114 depicts a direction of movement of the user's hand 112, to be received inside cavity 104. For ease of understanding, only one hand 112 is illustrated in FIG. 1. However, the disclosure is not so limited. It is anticipated that peripheral device 100 may be configured to receive both hands 112 of the user, and collect position, posture or movement data of both hands 112.

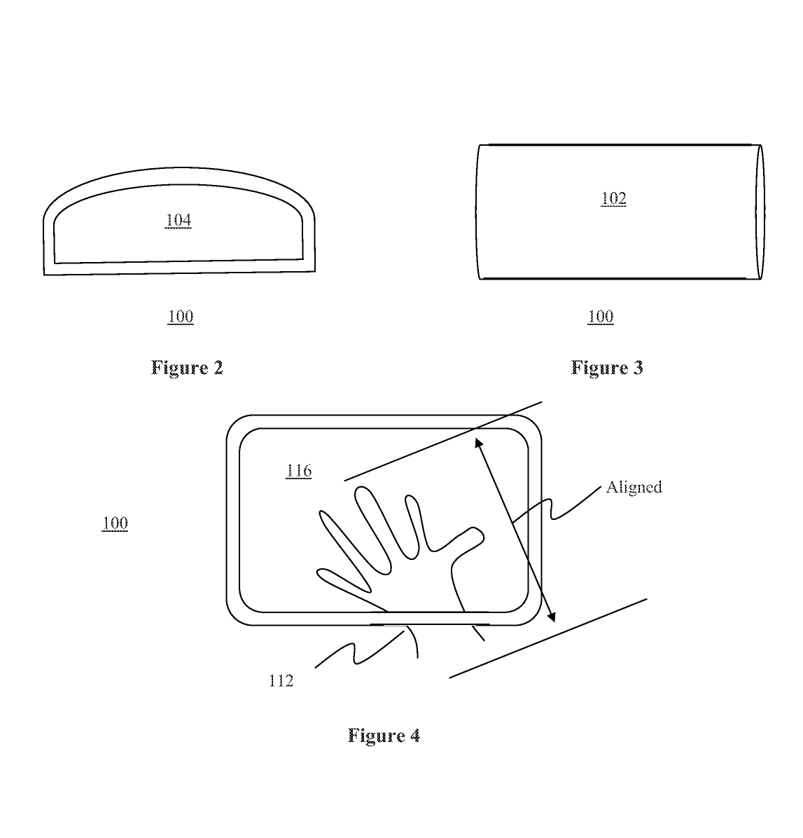

As illustrated in FIG. 2, in embodiments, peripheral device 100 has an elongated body with sufficient depth and/or height to enable most or entire length of the user hand or hands 112 to be received and move around, as well as assuming various postures, inside cavity 104. As illustrated in FIGS. 1 and 3, for the depicted embodiments, peripheral device 100 may be configured with a partial elliptical end. However, the disclosure is not so limited. For example, in alternate embodiments, peripheral device 100 may be configured with a rectangular or substantially rectangular shaped end instead. In still other embodiments, peripheral device 100 may be configured with an end shape of any one of a number of other geometric shapes.

In embodiments, visual feedback 116 may include a display of the received portion(s) of the user's hand(s) 112. In embodiments, as illustrated in FIG. 4, display of the received portion of the user's hand(s) 112 is (are) aligned with the un-inserted portion of the user's hand(s) 112. In embodiments, the display may be a high definition realistic rendition of the user's hand or hands 112 with a posture corresponding to the posture of the received portion(s) of the user's hand(s) 112. In embodiments, the display may further include a background and/or rendition of one or more virtual objects being interacted by the user using his/her hand or hands 112. Experiments had demonstrated that the user's mind may “fill the blank” and provide the user with an enhanced realism experience, in response to a substantially accurate visual representation of the user's interaction using his/her hand(s) 112.

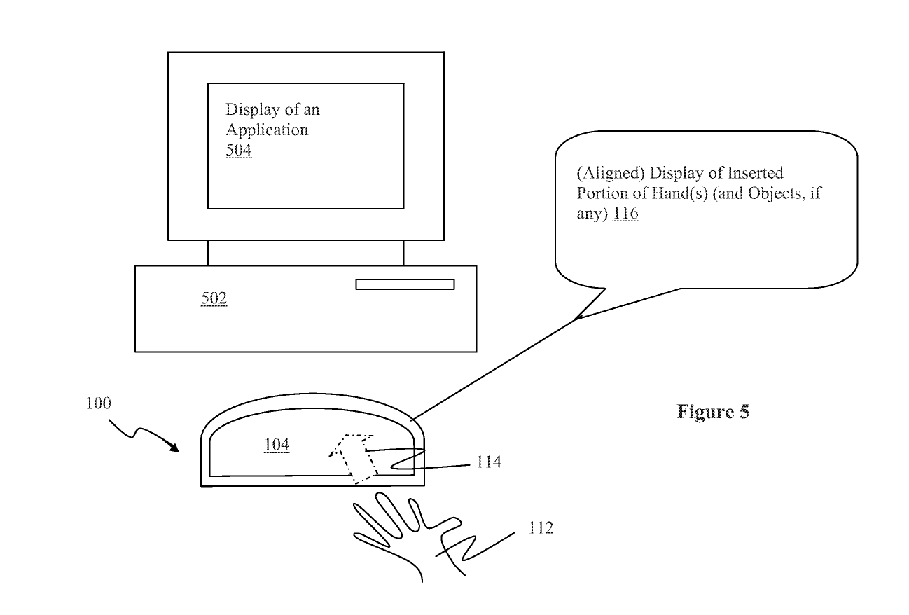

FIG. 5 illustrates various example usage of the peripheral device, in accordance with various embodiments. As illustrated, peripheral device 100 may be employed to facilitate a user of computer 502 to interact with computer 502, or more specifically, an application executing on computer 502. As described earlier, user may insert 114 his/her hand(s) 112 into cavity 104 of peripheral device 100, and move his/her hand(s) 112, assuming different postures, white inside cavity 104, to interact with computer 502. In response, peripheral device 100, alone or in cooperation with computer 502, depending on embodiments, may provide visual and/or tactile feedback to the user, to enhance the user's computing experience.

For example, the user may be interacting with a flight related application executing on computer 502. The application may render a terrestrial view of the horizon on display 504 of computer 502, while peripheral device 100, in cooperation with computer 502, may render a display of the user's hand(s) 112 operating the yoke of plane with a background of a cockpit of the plane being flown. Additionally, peripheral device 100, in cooperation with computer 502, may further provide tactile feedback to the user to provide the user with an experience of vibration or other mechanical force the user may feel from the yoke while in flight.

As another example, the user may be interacting with a driving or racing related application executing on computer 502. The application may render a terrestrial view of the street scene or racecourse on the display of computer 502, while peripheral device 100, in cooperation with computer 502, may render the user's hand(s) 112 operating the steering wheel, with a background of the dashboard of the automobile or race car being driven. Additionally, peripheral device 100, in cooperation with computer 502, may further provide tactile feedback to the user to provide the user with an experience of vibration from the speeding automobile or race car.

As still another example, the user may be interacting with a surgery related education application executing on computer 502. The application may render e.g., an operating room in the display of computer 402, while peripheral device 100, in cooperation with computer 402, may render the object, organ or body part receiving the surgery with the user's hand(s) 112 operating on the object/organ/body part (with one or more selected surgical instruments).

As still another example, the user may be interacting with an e-commerce related application executing on computer 502, in particular, interacting with the e-commerce related application in the selection of certain garments. The application may render a virtual showroom, including the virtual garments in the display of computer 502. Peripheral device 100, in cooperation with computer 502, may render a particular item the user's hand(s) 112 is (are) “touching.” Additionally, peripheral device 100, in cooperation with computer 502, may further provide tactile feedback to the user to provide the user a sense of the texture of the fabric of the garment being felt.

In addition to being a desktop computer, in various embodiments, computer 502 may be a server computer, a computing tablet, a game console, a set-top box, a smartphone, a personal digital assistant, or other digital computing devices.

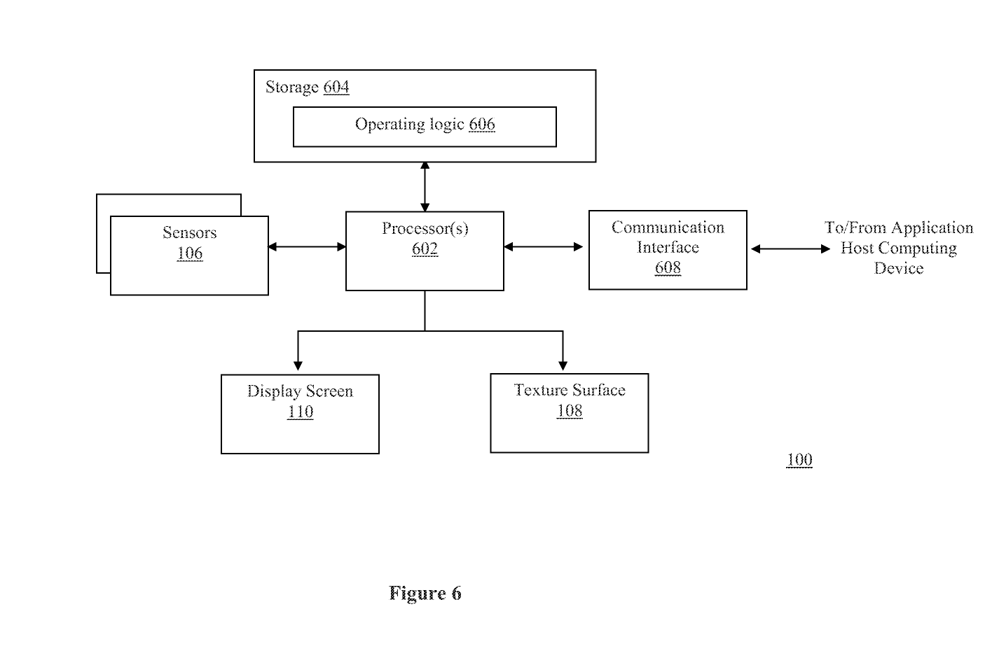

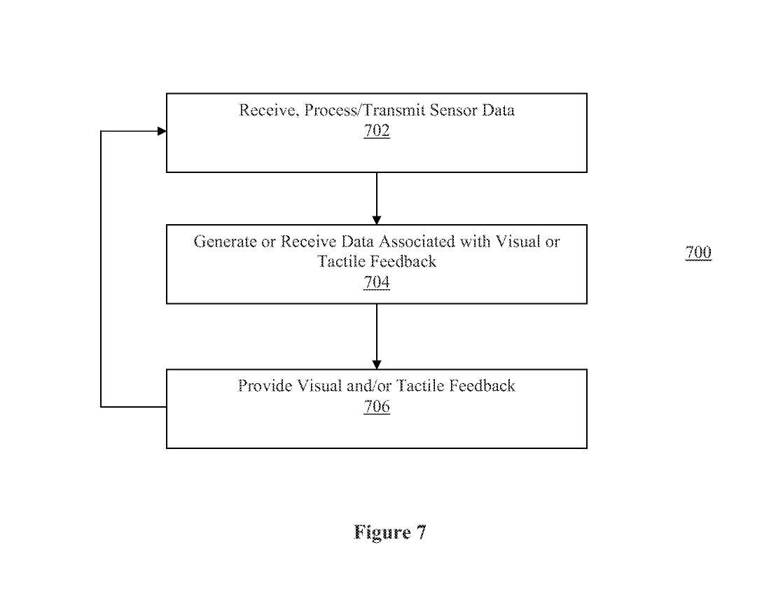

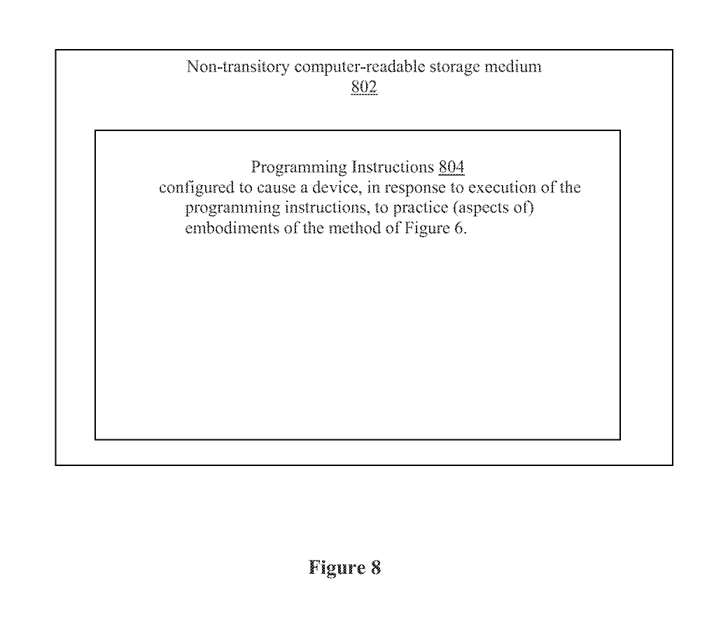

FIG. 6 illustrates an architectural or component view of the peripheral device, in accordance with various embodiments. In various embodiments, as illustrated, in addition to earlier described sensors 106, display screen 110 and variable texture surface 108, peripheral device 100 may further include processors 602, storage 604 (having operating logic 606) and communication interface 608, coupled to each other and the earlier described elements as shown.

As described earlier sensors 106 may be configured to detect and collect data associated with position, posture and/or movement of the user's hand(s), Display screen 110 may be configured to enable display of visual feedback to the user, and variable texture surface 108 may be configured to enable provision of tactile feedback to the user.

Processor 602 may be configured to execute operating logic 606. Processor 602 may be any one of a number of single or multi-core processors known in the art. Storage 604 may comprise volatile and non-volatile storage media configured to store persistent and temporal (working) copy of operating logic 606.

In embodiments, operating logic 606 may be configured to process the collected position, posture and/or movement data of the user's hand(s). in embodiments, operating logic 606 may be configured to perform the initial processing, and transmit the data to the computer hosting the application to determine and generate instructions on the visual and/or tactile feedback to be provided. For these embodiments, operating logic 606 may be further configured to receive data associated with the visual and/or tactile feedback to be provided from the hosting computer. In alternate embodiments, operating logic 606 may be configured to assume a larger role in determining the visual and/or tactile feedback, e.g., hut not limited to, the generation of the images depicting the user's hand(s). Either case, whether determined on its own or responsive to instructions from the hosting computer, operating logic 606 may be further configured to control display screen 110 and/or variable texture surface 108, to provide the visual and/or tactile feedback.

In embodiments, operating logic 606 may be implemented in instructions supported by the instruction set architecture (ISA) of processor 602, or in higher level languages and compiled into the supported ISA. Operating logic 606 may comprise one or more logic units or modules. Operating logic 606 may be implemented in an object oriented manner. Operating logic 606 may be configured to be executed in a multi-tasking and/or multi-thread manner.

In embodiments, communication interface 608 may be configured to facilitate communication between peripheral device 100 and the computer hosting the application. As described earlier, the communication may include transmission of the collected position, posture and/or movements data of the user's hand(s) to the hosting computer, and transmission of data associated with visual and/or tactile feedback from the host computer to peripheral device 100. In embodiments, communication interface 608 may be a wired or a wireless communication interface. An example of a wired communication interface may include, but is not limited to, a Universal Serial Bus (USB) interface. An example of a wireless communication interface may include, but is not limited to, a Bluetooth interface.

FIG. 7 illustrates a method of human-computer interaction, using the peripheral device, in accordance with various embodiments. As illustrated, in various embodiments, method 700 may begin at block 702. At block 702, the operating logic of peripheral device 100 may receive (e.g., from sensors 106) position, posture and/or movement data of the user's hand(s) 112. In response, the operating logic may process the position, posture and/or movement data, or transmit the position, posture and/or movement data to the hosting computer for processing (with or without initial processing).

From block 702, method 700 may proceed to block 704. At block 704, the operating logic may generate data associated with providing visual and/or tactile feedback, based at least in part on the position, posture or movement data of the user's hand(s) 112. In alternate embodiments, at block 704, the operating logic may receive the data associated with providing visual and/or tactile feedback from the hosting computer instead. In still other embodiments, the operating logic may generate some of the data itself, and receive the others from the hosting computer.

From block 704, method 700 may proceed to block 706. At block 706, the operating logic may control the display screen and/or the variable texture surface to provide the visual and/or tactile feedback, based at least in part on the data associated with the provision, generated or received.

Method 700 may be repeated continuously until the user pauses or ceases interaction with the computer hosting the application.

FIG. 8 illustrates an example non-transitory computer-readable storage medium having instructions configured to practice all or selected aspects of the method of FIG. 7; in accordance with various embodiments of the present disclosure. As illustrated, non-transitory computer-readable storage medium 802 may include a number of programming instructions 804. Programming instructions 804 may be configured to enable peripheral device 100, in response to execution of the programming instructions, to perform in full or in part, the operations of method 700.

Referring back to FIG. 6, for various embodiments, processor 602 may be packaged together with operating logic 606 configured to practice the method of FIG. 7. In various embodiments, processor 602 may be packaged together with operating logic 606 configured to practice the method of FIG. 7 to form a System in Package (SiP). In various embodiments, processor 602 may be integrated on the same die with operating logic 606 configured to practice the method of FIG. 7. In various embodiments, processor 602 may be packaged together with operating logic 606 configured to practice the method of FIG. 7 to form a System on Chip (SoC). In various embodiments, the SoC may be utilized in a smartphone, cell phone, tablet, or other mobile device.

Accordingly, embodiments described include, but are not limited to, a peripheral device for facilitating human interaction with a computing device that includes a device body having a cavity configured to receive one or more hands of a user of the computing device, and a plurality of sensors disposed inside the cavity to collect position, posture or movement data of the one or more hands as the user uses the one or more hands to interact with the computing device. The peripheral device may further include at least a selected one of a display screen disposed on an external surface of the body or a variable texture surface disposed inside the cavity to provide at least a corresponding selected one of visual or tactile feedback to the user, based at least in part on the position, posture or movement data of the one or more hands.

Further, the device body may be elongated and has a selected one of a partial elliptical end or a rectangular end. The cavity may be configured to receive both hands of the user. The peripheral device may further include a communication interface coupled with the sensors, and configured to transmit the position, posture or movement data of the one or more hands to the computing device. Or the peripheral device may further include a communication interface coupled with at least a selected one of the display screen or the variable texture surface, and configured to receive data, from the computing device, associated with at least a corresponding one of providing the visual or tactile feedback to the user. The data associated with providing the visual or tactile feedback to the user may include at least one of data associated with a background to be rendered as part of the visual feedback, data associated with a full or partial depiction of the one or more hands, or data associated with configuring the variable texture surface to provide the tactile feedback.

Additionally, the peripheral device may include a processor coupled to the sensors, and configured to at least contribute in processing the position, posture or movement data of the one or more hands for providing the visual or tactile feedback to the user. Or the peripheral device may further include a processor coupled to at least one of the display screen or the variable texture surface, and configured to at least contribute in providing a corresponding one of the visual or tactile feedback to the user. The processor may be configured to contribute in at least one of determining a background to be rendered as part of the visual feedback, determining a full or partial depiction of the one or more hands, or determining the variable texture surface to provide the tactile feedback.

In embodiments, the peripheral device may include both the peripheral device comprises both the display screen and the variable texture surface.

Embodiments associated with method for facilitating human interaction with a computing device have also been disclosed. The method may include collecting position, posture or movement data of one or more hands of a user of a computing device while the user moving or posturing the one or more hands within a cavity of a peripheral device to interact with the computing device; and providing to the user, at least a selected one of visual feedback, via a display screen of the peripheral device, or tactile feedback, via a variable texture surface of the peripheral device, wherein the providing is based at least in part on the position, posture or movement data of the one or more hands.

The collecting and providing may be performed for both hands of the user. The method may further include transmitting the position, posture or movement data of the one or more hands to the computing device. The method may further include receiving data, from the computing device, associated with at least a selected one of providing the visual or tactile feedback to the user. The data associated with providing the visual or tactile feedback to the user may include at least one of data associated with a background to be rendered as part of the visual feedback, data associated with a full or partial depiction of the one or more hands, or data associated with configuring the variable texture surface to provide the tactile feedback.

In embodiments, the method may further include processing, by the peripheral device, the position, posture or movement data of the one or more hands for providing the visual or tactile feedback to the user. The method may further include at least contributing, by the peripheral device, in providing the visual or tactile feedback to the user. Contributing may include contributing in at least one of determining a background to be rendered as part of the visual feedback, determining a full or partial depiction of the one or more hands, or determining the variable texture surface to provide the tactile feedback.

In embodiments, providing of the above method embodiments may include providing both the visual and the tactile feedback.

Embodiments of at least one non-transitory computer-readable storage medium have also been disclosed. The computer-readable storage medium may include a plurality of instructions configured to enable a peripheral device, in response to execution of the instructions by a processor the peripheral device, to collect position, posture or movement data of one or more hands of a user of a computing device while the user moves or postures the one or more hands within a cavity of the peripheral device to interact with the computing device; and provide to the user, at least a selected one of visual feedback, via a display screen of the peripheral device, or tactile feedback, via a variable texture surface of the peripheral device, wherein the providing is based at least in part on the position, posture or movement data of the one or more hands.

The peripheral device may also be enabled to perform the collect and provide operations for both hands of the user. The peripheral device may also be enabled to transmit position, posture or movement data of the one or more hands to the computing device. The peripheral device may also be enabled to receive data, from the computing device, associated with at least a selected one of provision of visual or tactile feedback to the user. The data associated with provision of visual Or tactile feedback to the user may include at least one of data associated with a background to be rendered as part of the visual feedback, data associated with a full or partial depiction of the one or more hands, or data associated with configuring the variable texture surface to provide the tactile feedback.

The peripheral device may also be enabled to process the position, posture or movement data of the one or more hands for provision of visual or tactile feedback to the user. The peripheral device may also be enabled to at least contribute in providing the visual or tactile feedback to the user. The contribution may include contribution in at least one of determination of a background to be rendered as part of the visual feedback, determination of a full or partial depiction of the one or more hands, or determination of the variable texture surface to provide the tactile feedback.

Provide in any one of the above storage medium embodiments may include provide both the visual and the tactile feedback.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present disclosure. This application is intended to cover any adaptations or variations of the embodiments discussed herein. Therefore, it is manifestly intended that the embodiments of the present disclosure be limited only by the claims.

What is claimed is:

1. A peripheral device for facilitating human interaction with a computing device, comprising:
a device body having a cavity configured to receive one or more hands of a user of the computing device;
a plurality of sensors disposed inside the cavity to collect position, posture or movement data of the one or more hands as the user uses the one or more hands to interact with the computing device; and
at least a selected one of a display screen disposed on an external surface of the body or a variable texture surface disposed inside the cavity to provide at least a corresponding selected one of visual or tactile feedback to the user, based at least in part on the position, posture or movement data of the one or more hands.

2. The peripheral device of claim 1, wherein the device body is elongated and has a selected one of a partial elliptical end or a rectangular end.

3. The peripheral device of claim 1, wherein the cavity is configured to receive both hands of the user.

4. The peripheral device of claim 1 further comprises a communication interface coupled with the sensors, and configured to transmit the position, posture or movement data of the one or more hands to the computing device.

5. The peripheral device of claim 1 further comprises a communication interface coupled with at least a selected one of the display screen or the variable texture surface, and configured to receive data, from the computing device, associated with at least a corresponding one of providing the visual or tactile feedback to the user.

6. The peripheral device of claim 5, wherein the data associated with providing the visual or tactile feedback to the user include at least one of
data associated with a background to be rendered as part of the visual feedback,
data associated with a full or partial depiction of the one or more hands, or
data associated with configuring the variable texture surface to provide the tactile feedback.

7. The peripheral device of claim 1 further comprises a processor coupled to the sensors, and configured to at least contribute in processing the position, posture or movement data of the one or more hands for providing the visual or tactile feedback to the user.

8. The peripheral device of claim 1 further comprises a processor coupled to at least one of the display screen or the variable texture surface, and configured to at least contribute in providing a corresponding one of the visual or tactile feedback to the user.

9. The peripheral device of claim 8, wherein the processor is configured to contribute in at least one of
determining a background to be rendered as part of the visual feedback,
determining a full or partial depiction of the one or more hands, or
determining the variable texture surface to provide the tactile feedback.

10. The peripheral device of claim 1, wherein the peripheral device comprises both the display screen and the variable texture surface.

11. A method for facilitating human interaction with a computing, device, comprising:
collecting position, posture or movement data of one or more hands of a user of a computing device while the user moving or posturing the one or more hands within a cavity of a peripheral device to interact with the computing device; and
providing to the user, at least a selected one of visual feedback, via a display screen of the peripheral device, or tactile feedback, via a variable texture surface of the peripheral device, wherein the providing is based at least in part on the position, posture or movement data of the one or more hands.

12. The method of claim 11, wherein the collecting and providing are performed for both hands of the user.

13. The method of claim 11 further comprises transmitting the position, posture or movement data of the one or more hands to the computing device.

14. The method of claim 11 further comprises receiving data, from the computing device, associated with at least a selected one of providing the visual or tactile feedback to the user.

15. The method of claim 11 further comprises processing, by the peripheral device, the position, posture or movement data of the one or more hands for providing the visual or tactile feedback to the user.

16. The method of claim 11 further comprises at least contributing, by the peripheral device, in providing the visual or tactile feedback to the user.

17. At least one non-transitory computer-readable storage medium having a plurality of instructions configured to enable a peripheral device, in response to execution of the instructions by a processor the peripheral device, to:
collect position, posture or movement data of one or more hands of a user of a computing device while the user moves or postures the one or more hands within a cavity of the peripheral device to interact with the computing device; and
provide to the user, at least a selected one of visual feedback, via a display screen of the peripheral device, or tactile feedback, via a variable texture surface of the peripheral device, wherein the providing is based at least in part on the position, posture or movement data of the one or more hands.

18. The storage medium of claim 17, wherein the instructions, in response to execution by a processor of the peripheral device, enable the peripheral device to perform the collect and provide operations for both hands of the user.

19. The storage medium of claim 17, wherein the instructions, in response to execution by a processor of the peripheral device, further enable the peripheral device to transmit the position, posture or movement data of the one or more hands to the computing device.

20. The storage medium of claim 17, wherein the instructions, in response to execution by a processor of the peripheral device, further enable the peripheral device to receive data, from the computing device, associated with at least a selected one of provision of visual or tactile feedback to the user.

21. The storage medium of claim 17, wherein the instructions, in response to execution by a processor of the peripheral device, further enable the peripheral device to process the position, posture or movement data of the one or more hands for provision of visual or tactile feedback to the user.

22. The storage medium of claim 17, wherein the instructions, in response to execution by a processor of the peripheral device, further enable the peripheral device to at least contribute in providing the visual or tactile feedback to the user.
